(19) United States
(12) Patent Application Publication
(10) Pub. No.: US 2007/0125477 A1
(43) Pub. Date: Jun. 7, 2007

(54) Method of manufacturing liquid crystal display panel

(76) Inventor: Mitsuaki Morimoto, Matsusaka-shi (JP)

Correspondence Address: BIRCH STEWART KOLASCH & BIRCH, PO BOX 747, FALLS CHURCH, VA, 22040-0747, US

(21) Appl. No.: 10/574,894

(22) PCT Filed: Sep. 15, 2004
(86) PCT No.: PCT/JP04/13421

§ 371 Date: Apr. 6, 2006

(51) Int. Cl. B32B 17/10; G02F 1/13

(52) U.S. Cl. 156/99; 349/187

(57) ABSTRACT

A method of manufacturing a liquid crystal display panel includes the steps of arranging a sealant on a main surface of at least two substrates to be bonded together, dropping a liquid crystal on one of the two substrates, and bonding the two substrates together, wherein the step of bonding includes the step of setting the sealant after the liquid crystal sandwiched between the two substrates is spread to contact the sealant along substantially a whole periphery of the sealant while both of the two substrates contact the sealant along the whole periphery of the sealant.

### TECHNICAL FIELD

The present invention relates to a method of manufacturing a liquid crystal display panel with a dropping and bonding method. That is, the present invention relates to a method of manufacturing a liquid crystal display panel including the steps of arranging a sealant on a main surface of at least one of two substrates to be bonded together, dropping a liquid crystal on one of the two substrates, and bonding the two substrates together.

### BACKGROUND ART

In manufacturing of a liquid crystal display panel, it is necessary to arrange two glass substrates, each having a transparent electrode, a thin film transistor array or the like previously provided on a surface thereof, opposite to each other with keeping a very small spacing of about a few μm, bond the glass substrates to each other with a sealant, fill the spacing with a liquid crystal, and perform sealing. When a large glass substrate (also referred to as a “mother glass substrate”) is used as a material of the substrate, a method as described below has been used for filling with a liquid crystal and sealing.

First, a plurality of seal patterns are arranged on a mother glass substrate in an environment of an atmospheric pressure. A sealant is arranged along an outer periphery of a region to be a liquid crystal cell on a surface of one mother glass substrate. The sealant is arranged to form a pattern having an “injection opening”, that is, an opening for injecting a liquid crystal into the liquid crystal cell, rather than a completely closed annular pattern. In this state, two mother glass substrates are bonded together, and pressing and setting are performed. The two mother glass substrates bonded and fixed to each other are referred to as a “bonded substrate”. Then, the bonded substrate is cut to a prescribed size with the injection opening of each pattern arranged in an end portion to obtain an empty liquid crystal cell. A conventional liquid crystal injection technique is applied to the empty liquid crystal cell obtained as above to inject a liquid crystal from the injection opening, and then the injection opening is sealed.

In the method of filling with a liquid crystal as described above, the steps of bonding two mother glass substrates together and filling with the liquid crystal must be performed separately.

In contrast, techniques as indicated in Japanese Patent Laying-Open No. 63-179323 (Patent Document 1) and Japanese Patent Laying-Open No. 11-109388 (Patent Document 2) have been proposed as methods which can concurrently perform these two steps. In each of these techniques, a liquid crystal is dropped on a surface of a substrate having a seal pattern formed thereon and, thereafter, two substrates are bonded together in a vacuum state to concurrently perform bonding of the substrates and filling with the liquid crystal. More specifically, a sealant is applied on one of two substrates to be bonded together in a vacuum state, a liquid crystal is dropped on one of the substrates, and the two substrates are bonded together.

Patent Document 1: Japanese Patent Laying-Open No. 63-179323

Patent Document 2: Japanese Patent Laying-Open No. 11-109388

### DISCLOSURE OF THE INVENTION

### Problems to be Solved by the Invention

Dropping and bonding in a vacuum state as described in the above-described documents includes problems as described below.

In Patent Document 1, a liquid crystal is dropped to multiple points in a matrix-like form so that the liquid crystal mounted on a substrate is diffused and reaches an inner side surface of each side of a sealant at substantially the same time. This may be possible in a liquid crystal display panel as indicated in a first embodiment of Patent Document 1 which has a seal-print dimension of 180 mm×80 mm, which corresponds to a diagonal dimension of at least 7 inches. In a small liquid crystal panel having a diagonal dimension of 1-2.4 inches which is used in a mobile phone or a digital still camera widely used in recent years, however, since a seal-print dimension thereof is as small as about 22 mm×17 mm to 50 mm×40 mm, one or two drops of a liquid crystal are desirably dropped to each cell in terms of ensuring accuracy of a tact time required for dropping and an amount of dropping. In this situation, it is difficult to perform dropping to multiple points and, since a seal pattern itself is small, the liquid crystal dropped in one or two drops and diffused to reach an inner side surface of each side of a sealant does not always reach the inner side surface of each side at substantially the same time. As a result, a thickness of an injected liquid crystal (hereafter referred to as a “cell thickness”) may become uneven, or the liquid crystal may not be spread over a whole inner surface of a seal and a gap may be left, that is, a so-called “vacuum bubble” may be generated.

In addition, in an embodiment of Patent Document 2, a sealant is set with ultraviolet or visible light before a spread liquid crystal contacts the sealant. This may also result in an uneven cell thickness or generation of a vacuum bubble. Problems as such become more serious in a small panel having a relatively long length of printing of the sealant to an area of a display region.

The present invention was made in view of conventional problems as described above. An object of the present invention is to provide a method of manufacturing a liquid crystal display panel which can implement a state of an even cell thickness without a vacuum bubble in a method of manufacturing a liquid crystal display panel with a dropping and bonding system.

### Means for Solving the Problems

To attain the above-described object, a method of manufacturing a liquid crystal display panel according to the present invention includes the steps of arranging a sealant on a main surface of at least one of two substrates to be bonded together, dropping a liquid crystal on one of the two substrates, and bonding the two substrates together, wherein the step of bonding includes the step of setting the sealant after the liquid crystal sandwiched between the two substrates is spread to contact the sealant along substantially a whole periphery of the sealant while both of the two substrates contact the sealant along the whole periphery of the sealant. With adopting this method, since the sealant is set when spreading of the liquid crystal and the sealant is substantially completed to substantially obtain a final thickness and a cell thickness becomes substantially even over a whole region, a state of an even cell thickness without a vacuum bubble can be readily implemented.

In the invention described above, the step of bonding preferably includes the step of setting the sealant after the liquid crystal sandwiched between the two substrates is spread to contact the sealant along a whole periphery of the sealant while both of the two substrates contact the sealant along the whole periphery of the sealant. With adopting this method, the liquid crystal spreads to corners of a liquid crystal cell and the cell thickness becomes stable more reliably and becomes even throughout the cell. Therefore, a state of an even cell thickness without a vacuum bubble can be implemented more reliably.

In the invention described above, the sealant is preferably an ultraviolet-setting sealant, and the step of setting includes the step of irradiating the sealant with ultraviolet light. With adopting this method, a liquid crystal display panel can be manufactured with setting of a sealant by a simple step of irradiation with ultraviolet light.

In the invention described above, the sealant is preferably an ultraviolet-setting and thermosetting sealant, and the step of setting includes the step of temporary setting wherein the sealant is irradiated with ultraviolet light and the step of main setting wherein the sealant is heated. With adopting this method, a liquid crystal display panel can be manufactured with setting of a sealant by two steps, that is, irradiation with ultraviolet light and heating. An amount of irradiation with ultraviolet light can be decreased as compared to a situation in which setting is completed with irradiation with ultraviolet light alone.

### Effects of the Invention

According to the present invention, since the step of setting is performed after spreading of a liquid crystal and a sealant is substantially completed, setting is performed after a cell thickness becomes stable and even. Therefore, a liquid crystal display panel having an even cell thickness and including no vacuum bubble can be obtained.

### BRIEF DESCRIPTION OF THE DRAWINGS

FIG. 1 is a plan view of a mother glass having a large number of seal patterns drawn thereon in a first embodiment according to the present invention.

FIG. 2 is a plan view and a cross-sectional view for describing a state just after bonding, which is one step of a method of manufacturing a liquid crystal display panel in the first embodiment according to the present invention.

FIG. 3 is a plan view and a cross-sectional view for describing a state after a lapse of about 20 seconds from opening of a vacuum chamber to an atmosphere, which is one step of the method of manufacturing a liquid crystal display panel in the first embodiment according to the present invention.

FIG. 4 is a plan view and a cross-sectional view for describing a state in which a liquid crystal spreads to cover substantially a whole region inside the seal pattern and a thickness of a sealant becomes even, which is one step of the method of manufacturing a liquid crystal display panel in the first embodiment according to the present invention.

### DESCRIPTION OF THE REFERENCE SIGNS

1: mother glass (of a side for printing a sealant), 2: seal pattern, 3: liquid crystal, 10: mother glass (of a side for dropping the liquid crystal), 21, 22, 23, 24: side (of the seal pattern).

### BEST MODES FOR CARRYING OUT THE INVENTION

As described above, a cell thickness is a thickness of a layer of a filling liquid crystal. It can also be said that the cell thickness is a thickness of internal space of a liquid crystal cell. The “liquid crystal cell” means space for housing a liquid crystal which is enclosed with two substrates on upper and lower sides and a sealant, or a container-like structure formed as such.

As a result of diligent studies carried out by inventors on causes of problems as described above which occur with application of techniques of Patent Documents 1 and 2, the following conclusion was formed.

A thickness of a liquid crystal cell is determined through a process as follows. First, a sealant is spread with a pressure applied to upper and lower substrates during bonding, that is, a mechanical pressure from a bonding apparatus, a pressure difference between vacuum space inside the liquid crystal cell and an atmospheric pressure outside the liquid crystal cell, or the like. A liquid crystal inside the liquid crystal cell is also spread at the same time. In this situation, each side of the sealant is spread in a substantially equal and constant speed when an inner side surface of the sealant is not in contact with the liquid crystal. When the inner side surface of the sealant contacts the liquid crystal in any portion of an annular sealant forming the liquid crystal cell, however, the sealant and the liquid crystal press each other in that portion. As a result, a speed of spreading of the sealant with the pressure applied to the upper and lower substrates is decreased only in that portion.

On the other hand, in a portion in which the inner side surface of the sealant is still not in contact with the liquid crystal, since the sealant is continuously spread with the pressure applied to the upper and lower substrates, a thickness thereof temporarily becomes smaller than that in the portion having the inner side surface of the sealant already contacting the liquid crystal.

Thereafter, decreasing of the thickness of the sealant stops when the thickness is decreased to a thickness of a seal portion spacer. The seal portion spacer is a spacer which is mixed in the sealant or formed on the substrate by a method such as photolithography. In a liquid crystal portion, on the other hand, decreasing of a thickness of the liquid crystal stops when the thickness is decreased to a thickness of an inside-cell spacer. The inside-cell spacer is a spacer which is distributed on the substrate or formed on the substrate by a method such as photolithography.

Then, when the liquid crystal spreads to contact substantially a whole periphery of the inner side surface of the sealant, in the portion having the inner side surface of the sealant precedently contacting the liquid crystal, the thickness of the sealant is also decreased to the thickness of the seal portion spacer and the thickness of the liquid crystal portion is decreased to the thickness of the inside-cell spacer, though the decreasing is delayed as compared to other portions.

In this situation, when setting of the sealant is started before the liquid crystal contacts substantially the whole periphery of the inner side surface of the sealant, the sealant in the portion having the inner side surface of the sealant precedently contacting the liquid crystal is set with a large thickness. This may result in unevenness of the cell thickness which occurs during application of techniques of Patent Documents 1 and 2. In addition, when the sealant is set with a partially large thickness, a portion having the cell thickness fixed to a value larger than a desired value is generated, and a capacity of the liquid crystal cell becomes larger than an expected value. As a result, the liquid crystal becomes insufficient and a vacuum bubble is generated. This may be a cause of generation of the vacuum bubble which occurs during application of techniques of Patent Documents 1 and 2.

In addition, when setting of the sealant is started before the liquid crystal contacts substantially the whole periphery of the inner side surface of the sealant, since the setting is performed during spreading of the liquid crystal, the sealant is set while a cell gap in a display region is still larger than a final value to be attained. Therefore, a distance between glass substrates varies in a portion near the sealant and in the display region, and is fixed with a distortion stress left between the portion near the sealant and the display region. This may also result in unevenness of the cell thickness.

The inventors found that the problems can be solved when, in the step of setting included in the step of bonding, the sealant is set after the liquid crystal sandwiched between the two substrates is spread to contact the sealant along substantially a whole periphery of the sealant while both of the two substrates contact the sealant along the whole periphery of the sealant. To verify this finding, the inventors carried out an experiment as described below.

### First Embodiment

(Construction)

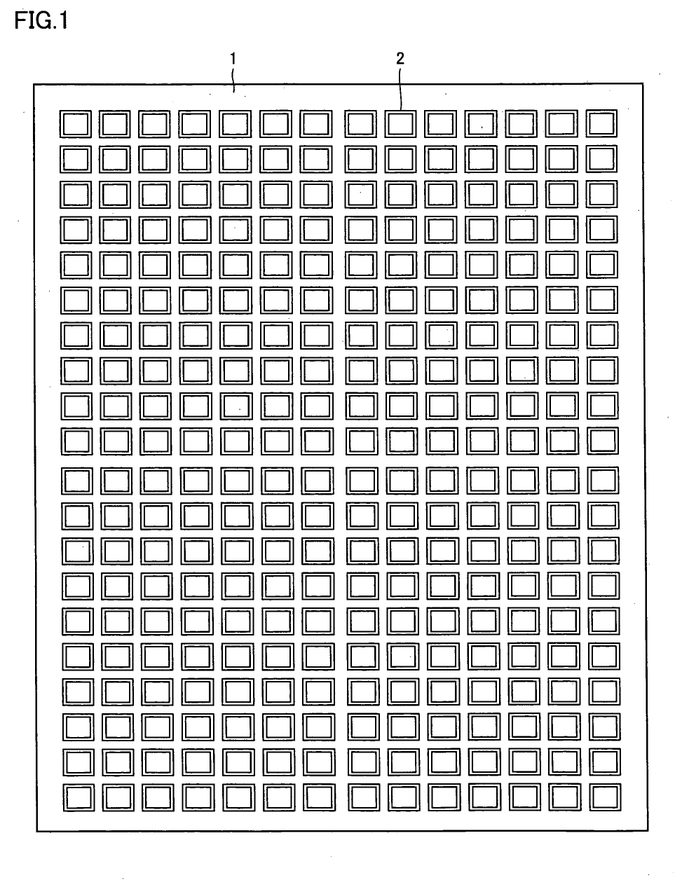

A method of manufacturing a liquid crystal display panel in a first embodiment according to the present invention will now be described referring to FIGS. 1-4(a), (b). FIG. 1 shows a mother glass 1 having a size of 620 mm×750 mm, on which patterns of a sealant (hereafter referred to as “seal patterns”) 2 are drawn, which patterns correspond to 280 cells formed with 14 columns×20 rows of panels each having a diagonal dimension of 1.5 inches. It is to be noted that, the “diagonal dimension of 1.5 inches” indicates a standard meaning that an outline of a region containing a liquid crystal has a diagonal line of 1.5 inches when the liquid crystal display panel is completed.

Seal pattern 2 has substantially a rectangular shape with long sides 21, 22 and short sides 23, 24. An inner dimension of seal pattern 2 is about 32 mm×24 mm. An average cell thickness after bonding is 4.25 μm, though the thickness is not even inside the cell. The liquid crystal dropped has a density of 1.01 g/cm3, and about 3.3 mg of the liquid crystal is dropped per one cell.

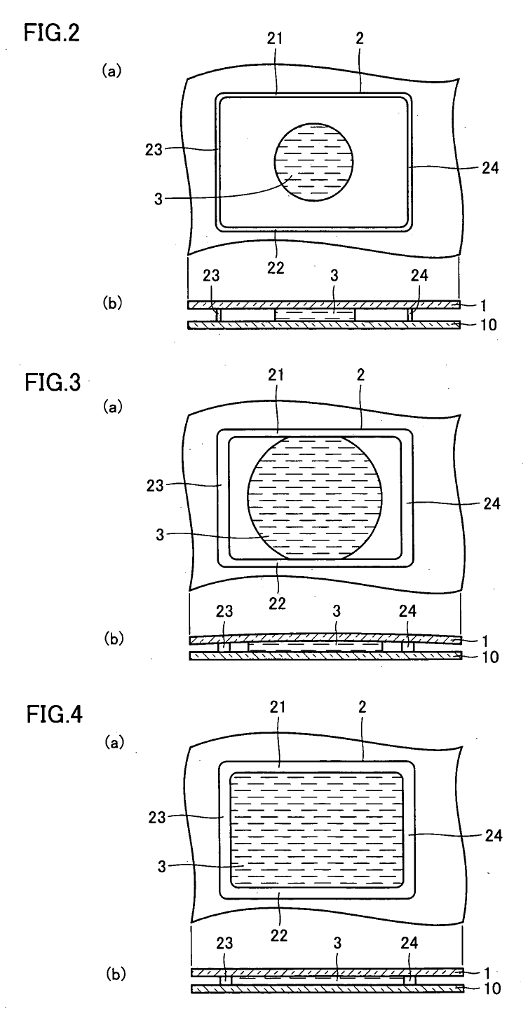

FIGS. 2-4 indicate a manner of spreading of the liquid crystal and the sealant inside a liquid crystal cell in the step of bonding included in the method of manufacturing a liquid crystal display panel in this embodiment. Herein, mother glass 1 having seal pattern 2 printed thereon and a mother glass 10 opposed thereto were prepared, the liquid crystal was dropped on a surface of mother glass 10, and then mother glass 1 was superposed on mother glass 10 to perform bonding. The liquid crystal was dropped to one point per one cell considering a tact time for a substrate.

FIG. 2(a), (b) shows a state just after bonding. The bonding is performed inside a vacuum chamber and the vacuum chamber is still not opened to an atmosphere. A liquid crystal 3 is not spread much.

FIG. 3(a), (b) shows a state after a lapse of about 20 seconds from opening of the vacuum chamber to the atmosphere. As a result of spreading of liquid crystal 3, though liquid crystal 3 is in contact with each of sides 21, 22 opposed to each other with a width of 24 mm, liquid crystal 3 still does not contact each of sides 23, 24 opposed to each other with a width of 36 mm. In this situation, a speed of spreading of the sealant is decreased in each of sides 21, 22 of seal pattern 2 since the sealant and liquid crystal 3 press each other, which results in a thickness larger than that in each of sides 23, 24.

FIG. 4(a), (b) shows a state in which liquid crystal 3 is in contact with sides 23, 24 in addition to sides 21, 22 and spreads to cover substantially a whole region inside seal pattern 2, and the thickness of the sealant becomes even.

As a result of observation by the inventors, a lapse of 40-50 seconds from opening of the vacuum chamber to the atmosphere after bonding was required to attain the state shown in FIG. 4(a), (b).

In this embodiment, the step of setting the sealant was started after a lapse of 90 seconds from opening of the vacuum chamber to the atmosphere after bonding of the substrates.

(Function and Effect)

According to this embodiment, a liquid crystal display panel having an even cell thickness and including no vacuum bubble could be obtained.

When an ultraviolet-setting sealant is used as the sealant, the step of irradiating the sealant with ultraviolet light may be performed in the step of setting.

When an ultraviolet-setting and thermosetting sealant is used as the sealant, the step of temporary setting wherein the sealant is irradiated with ultraviolet light and the step of main setting wherein the sealant is heated may be included in the step of setting.

An important point is, the step of bonding includes the step of setting the sealant after liquid crystal 3 sandwiched between two mother glasses 1, 10 is spread to contact the sealant along substantially a whole periphery of seal pattern 2 while both of two mother glasses 1, 10 contact the sealant along the whole periphery of seal pattern 2. It is more preferable when the term “along substantially a whole periphery” in this condition is replaced with “along a whole periphery”.

When the liquid crystal contact the sealant along substantially the whole periphery, spreading of the liquid crystal and the sealant is substantially completed to attain a final thickness or a thickness close to the final thickness. The cell thickness can be assumed to be stable when setting of the sealant is performed in this state. When the liquid crystal is in contact with the sealant completely along the whole periphery, the cell thickness becomes stable more reliably and becomes even throughout the cell. Therefore, setting of the sealant is more preferably performed when a state as such is attained.

Patent Document 2 described above refers to a problem of deterioration of a liquid crystal due to elution of a component of a sealant into the liquid crystal when the liquid crystal contacts the sealant before setting thereof. As a technology has progressed in recent years as compared to a time of application of Patent Document 2, however, a sealant has been developed which does not deteriorate a liquid crystal when brought into contact with the liquid crystal before setting. That is, a precondition largely differs from the time of application of Patent Document 2. When the present invention is implemented, the sealant which does not deteriorate a liquid crystal when brought into contact with the liquid crystal before setting can be appropriately selected and used to avoid deterioration of the liquid crystal.

It is to be noted that, though an example of dropping to only one point inside each cell is indicated in this embodiment, the present invention can also be applied when dropping to multiple points inside each cell is performed.

It is to be noted that, though a substrate of a side for dropping the liquid crystal and a substrate of a side for printing the sealant are distinct from each other in this embodiment, printing of the sealant and dropping of the liquid crystal may be performed on the substrate of the same side selected from two substrates. Alternatively, dropping of the liquid crystal may be performed on only one of the substrates, and printing of the sealant may be performed on both of the substrates.

The embodiment disclosed herein is illustrative in all points and is not restrictive. The scope of the present invention is indicated not by the description above but by the scope of the appended claims, and includes all modifications within the meaning and scope equivalent to the scope of the appended claims.

### INDUSTRIAL APPLICABILITY

The present invention can be applied to a method of manufacturing a liquid crystal display panel with a dropping and bonding method.

1. A method of manufacturing a liquid crystal display panel, comprising the steps of:
arranging a sealant on a main surface of at least one of two substrates to be bonded together;
dropping a liquid crystal on one of said two substrates; and
bonding said two substrates together; wherein
said step of bonding includes the step of setting said sealant after said liquid crystal sandwiched between said two substrates is spread to contact said sealant along substantially a whole periphery of said sealant while both of said two substrates contact said sealant along the whole periphery of said sealant.

2. The method of manufacturing a liquid crystal display panel according to claim 1, wherein
said step of bonding includes the step of setting said sealant after said liquid crystal sandwiched between said two substrates is spread to contact said sealant along a whole periphery of said sealant while both of said two substrates contact said sealant along the whole periphery of said sealant.

3. The method of manufacturing a liquid crystal display panel according to claim 1, wherein
said sealant is and ultraviolet-setting sealant, and said step of setting includes the step of irradiating said sealant with ultraviolet light.

4. The method of manufacturing a liquid crystal display panel according to claim 1, wherein
said sealant is an ultraviolet-setting and thermosetting sealant, and said step of setting include the step of temporary setting wherein said sealant is irradiated with ultraviolet light and the step of main setting wherein said sealant is heated.
